(19) United States
(12) Patent Application Publication
(10) Pub. No.: US 2019/0055970 A1
(43) Pub. Date: Feb. 21, 2019

(54) INDICATORS AND ASSEMBLIES THEREOF

(71) Applicant: LISI AEROSPACE CANADA CORP., Dorval (CA)

(72) Inventor: Farrell CAMPBELL, Hudson Heights (CA)

(73) Assignee: LISI AEROSPACE CANADA CORP., Dorval (CA)

(21) Appl. No.: 15/770,497

(22) PCT Filed: Oct. 26, 2016
(86) PCT No.: PCT/CA2016/051237

§ 371 Date: Apr. 24, 2018

(30) Foreign Application Priority Data
Oct. 26, 2015 (CA) 2910694

(51) Int. Cl. F16B 1/00; F16B 31/02; F16B 37/14; F16B 23/00

(52) U.S. Cl. CPC F16B 1/0071; F16B 31/02; F16B 13/124; F16B 23/0069; F16B 23/0061; F16B 37/14

(57) ABSTRACT

An indicator and a fastener and indicator assembly have an inwardly extending engagement portion on the indicator for engaging a complementary portion on the fastener. The fastener may include an annular groove and the indicator may include a complementary annular rim for extending into the annular groove of the fastener. A portion or all of the indicator may be resiliently flexible, and configured so that part or all of the indicator is stretched when in place on the fastener. Examples of fasteners may include nuts and/or bolts.

### REFERENCE TO RELATED APPLICATIONS

This application claims priority from Canadian Application No. 2,910,694 filed on 26 Oct. 2015 and entitled NUT INDICATORS AND ASSEMBLIES THEREOF. For purposes of the United States, this application claims the benefit under 35 U.S.C. § 119 of Canadian Application No. 2,910,694 filed on 26 Oct. 2015 and entitled NUT INDICATORS AND ASSEMBLIES THEREOF which is hereby incorporated herein by reference for all purposes.

### BACKGROUND

These inventions relate to indicators, for example nut indicators, bolt indicators and assemblies of nuts and nut indicators and/or bolts and bolt indicators. Indicators may be used on bolts and/or wheel nuts of cars, buses or other vehicles, or on wheel bolts and/or nuts of aircraft. Generally speaking, such indicators and assemblies thereof may be used in any other application requiring a means to minimize or detect unthreading or looseness of bolts and/or nuts when fastened onto a mating male or female threaded element.

### RELATED ART

GB 2,513,155 shows a fastener and a collar fitted over the fastener where the collar rotates with the fastener and indicates how much the fastener may have rotated over time, described as clamp load relaxation, for example by counter loading, vibration, or otherwise. A nut (1, 101) includes wrenching flats and a skirt for bearing against a workpiece. The nut includes internal threads for mating with complementary threads on a male fastener. An annular groove extends around the circumference of the nut on a side of the wrenching flats opposite the skirt. The nut is fitted with a plastic collar (3, 103) having an inner profile that matches the profile of the nut such that the collar rotates with the nut, and an indicator (9, 121) that indicates the amount of rotation of the nut relative to a mark or other indicator.

GB 2,325,505 shows a nut position indicator and dust cap 24, which may have a noncircular outer shape.

### SUMMARY

An indicator according to one embodiment comprises a body extending along an axis, and includes an intermediate portion defining a bore having a bore surface. The bore surface includes a plurality of surface portions configured to substantially conform to a complementary surface on an external portion of a fastener, a base portion at a first end of the body and extending partially around a perimeter of the first end of the body and including an indicator portion, and a resiliently flexible engagement portion at a second end of the body opposite the first end and having a portion extending inward relative to an outer surface of the body.

The resiliently flexible engagement portion is formed to be resiliently flexible enough so that the portion can extend over and engage a complementary surface on a fastener so that the resiliently flexible engagement portion and the complementary surface limit removal of the indicator without or until a suitable removal force being applied.

The indicator may have the following specific features, taken alone or in combination:
the plurality of surface portions extend axially and conform to a plurality of wrenching surfaces on a fastener,
the indicator is formed from a single material,
the outer surface of the body includes axially extending outer surfaces configured for manual gripping or wrenching,
a portion of the bore at the first end of the body includes a frustoconical surface,
the resiliently flexible engagement portion includes an arcuately-extending rim extending inwardly relative to an outer surface of the body,
the rim extends in a circle around the second end of the body,
the resiliently flexible engagement portion includes a frustoconical surface on an interior portion extending at an angle inward from the bore surface,
the resiliently flexible engagement portion forms an end surface of the indicator.

The invention is also about an assembly of an indicator according to any embodiment of the invention and a fastener. The fastener includes a body with an external surface having wrenching surfaces substantially conforming to the plurality of surface portions in the bore of the indicator, and surface with helical engagement surfaces for engaging a complementary fastener. The fastener body includes an engagement surface for receiving at least a portion of the inwardly extending portion of the indicator.

The invention is also about a hub assembly having at least one assembly of an indicator according to any embodiment of the invention and a fastener according to any embodiment of the invention.

The invention is also about a kit for containing a plurality of indicators, the kit comprising a container and a plurality of indicators according to any embodiment of the invention.

These and other examples are set forth more fully below in conjunction with drawings, which are to scale, a brief description of which follows.

### BRIEF DESCRIPTION OF THE DRAWINGS

FIG. 1 is an upper isometric view of an assembly of a nut and a nut indicator.

FIG. 2 is a side elevation and partial longitudinal cross section view of the assembly of FIG. 1.

FIG. 3 is an upper isometric view of the nut indicator of FIG. 1.

FIG. 4 is a top plan view of the nut indicator of FIG. 3.

FIG. 5 is a sagittal cross-section of the nut indicator of FIG. 3.

FIG. 6 is a side elevation and partial longitudinal cross section of the nut of FIG. 1.

FIG. 7 is a longitudinal cross section of the assembly of FIG. 1.

FIG. 8 is a schematic representation of a kit having a container and contents, including nut indicators.

FIG. 9 is a schematic representation of a kit having a container and contents, including one or more nuts and nut indicators.

FIG. 10 is a side elevation of an assembly according to a second embodiment of the invention.

FIG. 11 is a longitudinal cross section view of the assembly of FIG. 10.

FIG. 12 is a detail of FIG. 11.

FIG. 13 is a top plan view of a wheel hub assembly comprising assemblies of FIG. 10.

FIG. 14 is a detail of a longitudinal cross section view of the wheel hub assembly of FIG. 13.

### DETAILED DESCRIPTION

This specification taken in conjunction with the drawings sets forth examples of apparatus and methods incorporating one or more aspects of the present inventions in such a manner that any person skilled in the art can make and use the inventions. The examples provide the best modes contemplated for carrying out the inventions, although it should be understood that various modifications can be accomplished within the parameters of the present inventions.

Examples of indicators and of methods of making and assembling indicators with nuts or bolts are described. Depending on what feature or features are incorporated in a given structure or a given assembly, benefits can be achieved in the structure or the assembly. For example, indicators using an engagement surface or element for engaging with a nut or a bolt may be easier to assemble and may be more securely engaged with the nut or bolt.

Improvements are also provided in assemblies of the indicators and fasteners, such as nuts and/or bolts on which they are placed. Assemblies of a fastener and indicator such as those described herein can be easier to handle, and the indicator can be held more securely on the fastener. A fastener and indicator assembly can also be configured so that the possibility of axial withdrawal of the indicator from the fastener is reduced unless enough force is applied to the indicator.

These and other benefits will become more apparent with consideration of the description of the examples herein. However, it should be understood that not all of the benefits or features discussed with respect to a particular example must be incorporated into an indicator, assembly or method in order to achieve one or more benefits contemplated by these examples. Additionally, it should be understood that features of the examples can be incorporated into an indicator, assembly or method to achieve some measure of a given benefit even though the benefit may not be optimal compared to other possible configurations. For example, one or more benefits may not be optimized for a given configuration in order to achieve cost reductions, efficiencies or for other reasons known to the person settling on a particular product configuration or method.

Examples of a number of indicator configurations and of methods of making and assembling the indicators are described herein, and some have particular benefits in being used with a particular fastener configuration. However, even though these apparatus and methods are considered together at this point, there is no requirement that they be combined, used together, or that one component or method be used with any other component or method, or combination. Additionally, it will be understood that a given component or method could be combined with other structures or methods not expressly discussed herein while still achieving desirable results.

It should be understood that terminology used for orientation, such as front, rear, side, left and right, upper and lower, and the like, are used herein merely for ease of understanding and reference, and are not used as exclusive terms for the structures being described and illustrated.

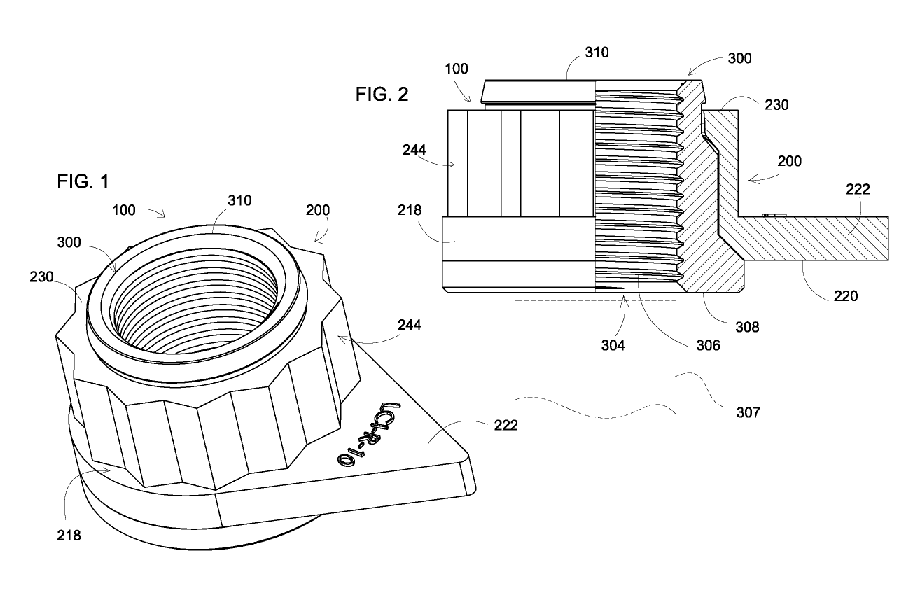

An indicator can be used on nuts having a number of configurations, one of which is described herein. An assembly 100 (FIGS. 1-2 and 7) of an indicator 200 and a nut 300 can be used with a respective bolt, stud, pin or other fastener for securing the bolt, stud, pin or other fastener in place. A bolt or pin will be described herein for an exemplary male fastener, but it is understood that other male fasteners and other fastener configurations can be used with the indicator described herein.

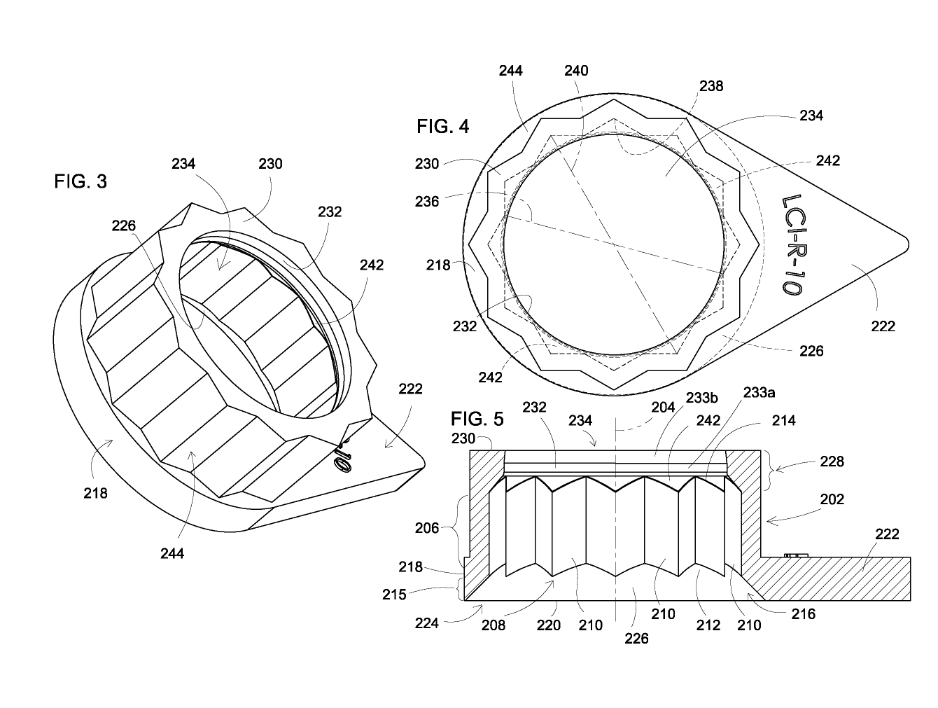

The indicator includes a body 202 (FIG. 3-5) extending along a longitudinal axis 204 (FIG. 5). The body includes an intermediate portion 206, helping to define a bore 208 through the body from a first end to a second end. The surface of the bore includes a plurality of surface portions, or rotation limiting surfaces, in the present example polygonal surfaces 210. The polygonal surfaces 210 are configured to substantially conform to complementary surfaces, described more fully below, on an external portion of the nut 300 or a pin 600. As used herein, “substantially” shall mean the designated parameter or configuration, plus or minus 10%. The polygonal surfaces 210 in the present example are bi-hexagonal surfaces that will engage complementary bi-hexagonal surfaces on the nut 300 or pin 600. The polygonal surfaces may be hexagonal surfaces that will engage complementary hexagonal surfaces on a nut, pin or other similarly-configured fastener.

Each of the polygonal surfaces 210 are substantially identical, and extend axially from a lower portion 212 to an upper portion 214. The polygonal surfaces are substantially continuous in between, and are spaced uniformly around the interior of the bore 208.

The indicator also includes a base portion 215 at a first or lower end 216 of the body 202. The base portion may include a rim 218 extending radially outward of the body 202 so that the base is wider than the rest of the body. The rim 218 extends upward from a bottom surface 220 (FIG. 5) of the body. The base portion also includes an indicator portion 222, which may be a pointer, asymmetric perimeter portion or other structure sufficiently strong for helping to limit rotation of the fastener, for example the nut, pin or other fastener element and/or designating a known position on a perimeter of the body. The indicator portion is positioned on assembly with a fastener to engage a structural element such as a surface on an underlying structure, for example a wheel hub, or an adjacent indicator portion and/or point to a known location. In the present example, the indicator portion 222 and the rim 218 have the same thickness and are continuous with each other, the rim 218 extending around the rest of the base portion not occupied by the indicator portion. The indicator portion 222, as viewed from above or below, converges at an angle of approximately 60° on a radius intersecting the central axis 204, the sides of which are substantially tangent to the respective rim surfaces.

The base portion 214 of the body includes an approach or entrance area 224, extending from the bottom surface 220 into the bore 208. In the present example, the entrance area 224 is defined by a substantially frustoconical surface 226. The frustoconical surface 226 in the present example extends completely around the opening in the bottom surface 220 and an angle to help guide the indicator over the exposed end of a nut, head of a pin, or other fastener element. The angle of the frustoconical surface relative to the central axis 204 may be selected so as to substantially conform to an adjacent angle on a nut surface or head surface when the indicator is placed over the nut or pin so that the frustoconical surface 226 contacts the adjacent nut surface.

An upper or top portion 228 (FIG. 5) of the indicator extends from the body to a top surface 230, a second end opposite the bottom surface 220. The upper portion 228 includes a resiliently flexible engagement portion, in the present case an inwardly-extending rim 232. The rim 232 forms a wall defining an upper opening 234 in the body into the bore. The rim 232 is formed to be resiliently flexible enough so that the rim can extend over and engage a complementary surface on the nut so that the rim and the complementary surface limit removal of the indicator without or until a suitable removal force being applied. In the present example, the rim is substantially circular forming a bore in the upper opening 234. The rim includes an axially-extending portion 233a in a lower portion of the rim extending to a slightly converging or, in the case of a constant angle, a frustoconical portion 233b in an upper portion of the rim, terminating at the top surface 230. The frustoconical portion 233b extends inward toward the central axis 204 (FIG. 5) of the indicator at an acute angle to the axis. However, in other examples, the resiliently flexible engagement portion can be a single structure extending inwardly into the bore, or can be a plurality of projections distributed discreetly, uniformly or otherwise about the opening and extending inwardly into the bore, for engaging a complementary structure or structures on the nut. In an example of a single projection or a plurality of projections distributed discreetly, uniformly or otherwise about the opening, at least one or each projection can have an interior surface extending at an acute angle to the axis 204 or alternatively extending in a plane (not shown) extending at an acute angle to the axis.

The inwardly-extending rim 232, or other resiliently flexible engagement portion, is preferably dimensioned so as to reliably engage the complementary surface on the fastener, and reduce the likelihood that the indicator disengages without being manually removed or otherwise intentionally pulled off the fastener. In the present example, the rim 232 extends radially inward toward the central axis equal to or slightly greater than (beyond) the smallest or minor diameter 236 (FIG. 4) of the polygonal surfaces 210. In such an example, the rim 232 extends inwardly a significant distance beyond the grooves 238 in the bore, which also means the rim extends over the complementary adjacent surface on the nut or bolt in the exemplary fasteners. A larger or major diameter 240 extends between opposite grooves 238, and represents the largest diameter of the bore in the present example. The rim or other resiliently flexible engagement portion can extend further inward toward the central axis 204 to reduce the diameter of the opening 234.

The polygonal surfaces 210 transition inward and upward to the rim 232 along suitable surfaces. In the present example, the polygonal surfaces 210 transition along the adjacent angled surfaces 242 (FIG. 5), allowing the bore 208 to transition to the rim 232.

In the present examples, the outer perimeter surface of the intermediate portion 206 of the body and upper portion 228 of the indicator include outer manual gripping surfaces 244 or outer wrenching surfaces 244, in the present example axially extending bi-hexagonal outer surfaces 244. In the present example, the bi-hexagonal outer surfaces 244 are formed to complement the similar surface variations of the polygonal surfaces 210 in the bore. This allows the body to have a relatively uniform thickness circumferentially than otherwise. The outer surface of the body and the upper portion may also be circular or smooth, or may have other desired surface configurations. For instance, the outer surfaces 244 of the body can be formed differently than the polygonal surfaces 210 in the bore. For example, the outer surfaces 244 of the body can be hex or other geometric shape, and the polygonal surfaces 210 in the bore can be bi-hex or other geometric shape different from the outer surfaces, or vice versa. The outer surfaces 244 allow the fastener to be retightened or positioned without removing the indicator, for instance with an appropriate or a standard tool.

The indicator in the present examples is formed from a single material. The indicator is monolithic. The material is flexible, and in the present example resiliently flexible enough so that the indicator can easily fit over the complementary portion of a fastener and snuggly conform to the adjacent outside surface of the fastener without cracking or being permanently deformed. The material may be a polymeric resin, such as nylon or TORLON® material or engineered plastics. In the present example, the polygonal surfaces 210 are dimensioned according to the design of the nut on which it is intended to be used to provide a snug fit, for example where the body is stretched when the indicator is placed over the complementary portion of the nut. In this example, the body of the indicator is unable to return to its relaxed state until it is removed from the fastener, the corresponding portion of the fastener being slightly larger in dimension than the corresponding interior surfaces of the indicator. In this configuration, the indicator can be placed over the corresponding portion of the fastener and the body and rim snapped into place on the fastener.

In other configurations, the indicator can be formed from a plurality of materials, such as by co-molding or other known techniques. For example, the inwardly-extending projection on the indicator for engaging a portion of the fastener can be formed from a more resilient material than the body. The body can be formed to easily fit over the wrenching portion of the fastener, and the engaging portion resiliently snapping at a place on the corresponding surface of the fastener. Additionally, other parts of the indicator, for example a base or the indicator portion, may be formed from a harder material or a softer material than the engaging portion at the upper portion of the indicator. The indicator may also be closed at the top or have a further reduced opening above the rim 232, with sufficient allowance being provided for the rim to resiliently flex over a portion of a fastener and engage a complementary surface, in one example snapping into place.

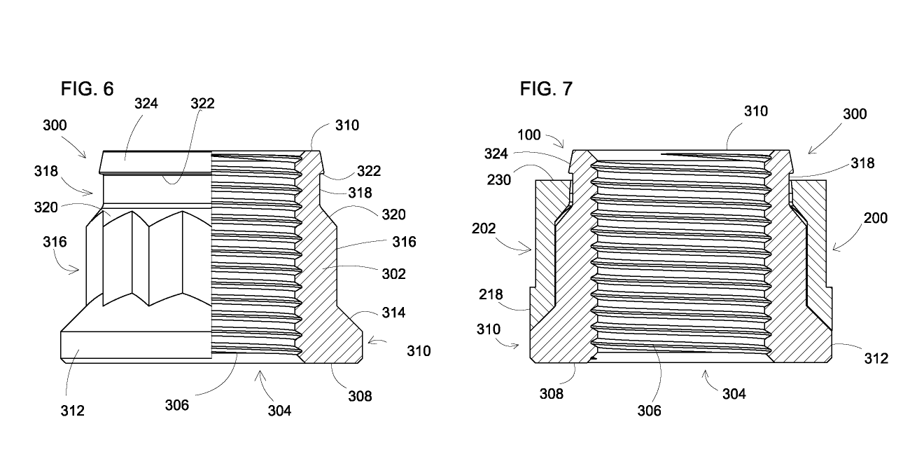

One example of a fastener with which the indicator can be used is a nut 300. The nut 300 can take a number of configurations. In the illustrated example, the nut 300 (FIGS. 1-2 and 6-7) includes a body 302 having a bore 304 internally threaded 306 or otherwise configured to engage a complementary male fastener 307, for example with helical engagement surfaces. The nut extends from a base surface 308 to a top surface 310. In the present example, the threads 306 extend the entire length of the bore from the bottom surface to the top surface. In another example, the threads extend only a portion of the length of the bore, especially when the nut has one or two counterbores formed near the base surface. The nut includes a base 310 forming a collar 312 around the base of the nut. A frustoconical surface 314 extends upward and inward from the base 310 to a plurality of wrenching surfaces 316. The slope or angle of the frustoconical surface 314 is complemented by the slope or angle of the frustoconical surface 226 in the indicator.

The wrenching surfaces can take a number of configurations, and in the present example are bi-hexagonal wrenching surfaces. The interior polygonal surfaces 210 in the indicator are configured to conform and complement the wrenching surfaces 316 on the nut in the present example. The inside dimensions of the polygonal surfaces 210 are selected so that they are slightly smaller than the outside dimensions of the wrenching surfaces 316, so that the indicator fits snugly or tightly over the wrenching surfaces.

The wrenching flats 316 terminate or transition to a circumferential or annular groove 318 in the outside surface of the body of the nut. In the present example, the transition 320 to the annular groove 318 occurs with a plurality of surfaces at the ends of the wrenching flats, which plurality of surfaces join or approximate a frustoconical surface. The angled surface 242 in the interior of the indicator approximates or is complementary to the frustoconical surface 320. The annular groove 318 has a substantially cylindrical external surface, extending continuously about the circumference of the nut. The annular groove 318 receives and positions the rim 332 at the upper portion of the indicator in the annular groove. The annular groove 318 terminates at a lip or shoulder 322 extending radially outward about the circumference of the nut from the annular groove 318.

The shoulder 322 extends upward to the top surface 310. In the present example, the outer wall of the shoulder 322 forms a frustoconical surface 324 extending upward and slightly inward to the top surface 310. The frustoconical surface 324 makes easier the installation of the indicator over the nut. Other surface configurations are also possible.

The indicator 200 can be assembled onto the nut 300 by positioning the entrance surface 224 over the frustoconical surface 324 on the nut 300. The indicator is pivoted so that the indicator 222 points to the desired position on the assembly and the polygonal surfaces 210 align with the wrenching flats 316 on the nut. The indicator is then pressed onto the nut until the angled surfaces 242 (FIGS. 3-5) contact the frustoconical surface 324 of the nut. The indicator is then pressed further so that the rim 332 extends outwardly and travels over the frustoconical surface 324 and lip 322 until the rim 332 falls into place in the annular groove 318. Axial movement of the indicator is then limited in both axial directions, and axial removal of the indicator would be difficult without a sufficient removal force on the indicator. The lower frustoconical surface 226 on the indicator contacts the lower frustoconical surface 314 on the nut, and the angled surfaces 242 below the rim 232 on the indicator rest against the frustoconical surface 320 on the nut.

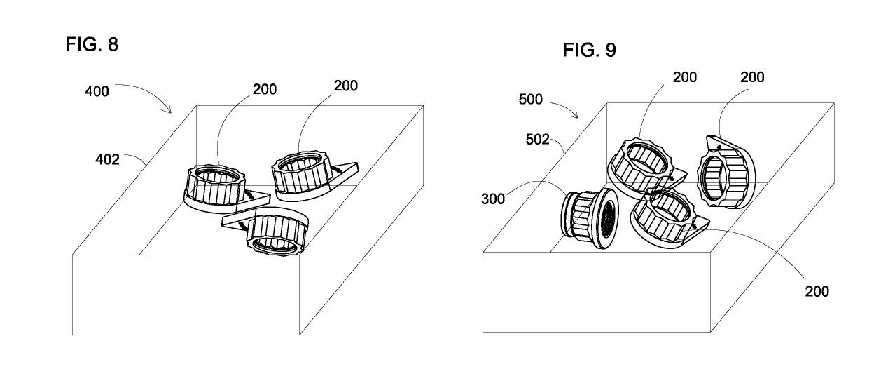

A plurality of indicators 200 can be assembled for inclusion in a kit, for example kit 400 (FIG. 8). In this example, the kit includes a container 402 of the desired construction for storing, shipping and/or protecting nut indicators such as those described herein. In the example of the kit 400 in FIG. 8, the kit contains only indicators 200, for example indicators such as any of those described herein. In one example, the indicators 200 are all identical. In another example, at least one indicator in the kit is different from another indicator. For example, the at least one indicator may have a different axial length corresponding to a first nut having a first axial length, and wherein at least one other indicator has a different axial length corresponding to a second nut having a second axial length. The indicators can be identical in all other respects, or may have other differences as desired. Indicators having different configurations can be marked or labeled according to a selected identification scheme, to make easier matching with an intended nut.

In another example of a kit, a plurality of indicators 200 can be assembled for inclusion in a kit, for example kit 500 (FIG. 9) with one or more nuts 300. In one example, all of the indicators 200 are identical and are specifically intended for use with a fastener such as the nut 300 and/or pin (not shown) in the same kit, for example where there is a plurality of such nuts 300. In another example, the indicators 200 can be identical except for one or a plurality of identifiable characteristics, such as axial length, wrenching configuration, indicator size, and the like. Other combinations of indicators and/or fastener configurations can be included in the kit, within a suitable container 502.

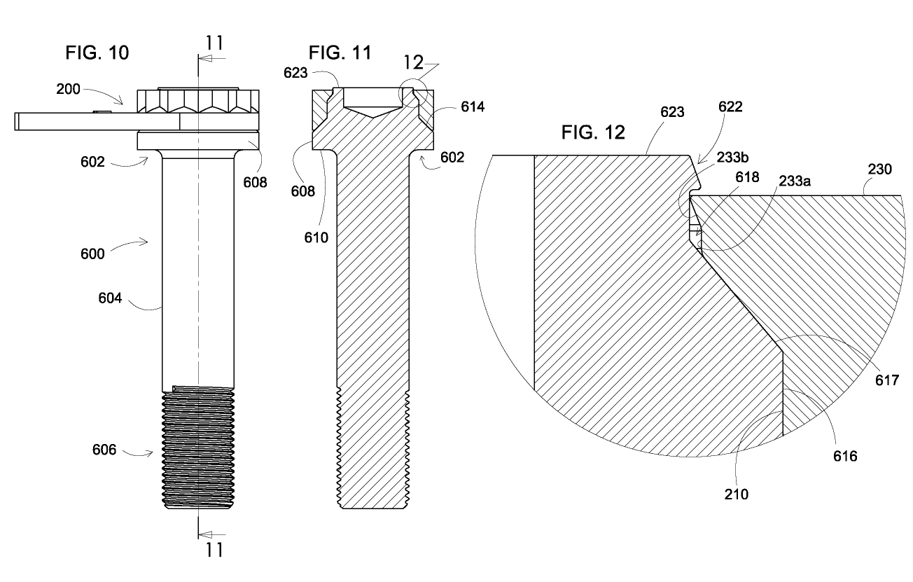

Another example of a fastener with which the indicator 200 can be used includes a pin, bolt or other male threaded fastener 600 (FIGS. 10-14). In the illustrated example, the pin 600 includes a head 602 at a first end portion of the pin extending circumferentially about a central axis, for example as indicated by the section line 11-11 in FIG. 10. A shank 604 extends axially from the head 602 two a threaded end portion 606 at an end of the fastener opposite the head 602. The pin 600 can be any conventional pin and may be modified for example at the head 602 as described herein. The threaded end portion 606 of the pin 600 can be used with any nut element as described herein, or any other suitable nut configuration.

The head 602 of the pin includes a radially-extending rim 608 having a substantially planar lower surface 610 for contacting and bearing against a surface on a structure to be secured by the fastener. In the present example, the rim 608 is substantially right-circular cylindrical and extends upward from the lower surface 610. They head 602 includes a frustoconical surface 614, in the present example extending upward and inward from the rim 608 at a desired angle. In the present example, the angle is substantially complementary to the angle of the frustoconical surface 226 of the indicator 200, or can have a different angle or conform to an indicator having a different geometry than indicator 200.

The pin 600 includes wrenching surfaces 616 extending substantially axially from the frustoconical surface 614. The wrenching surfaces 616 in the present example are configured to be substantially identical to the geometry of the wrenching surfaces 316 of the nut so that the head of the pin can receive and accept any of the indicators 200 that can be placed on and received by the nut 300. The tops of the wrenching surfaces terminate at respective surfaces 617 forming a frustoconical surface geometry extending circumferentially around the head of the pin. In the present example, the frustoconical geometry 617 is complementary to the frustoconical surface or angled surface 242 in the interior of the indicator 200. Alternatively, the head of the pin can have a different geometry, for example one which may still accept the indicator 300, or one which accepts an indicator having a different internal geometry. In the present example, the wrenching surfaces are bi-hexagonal wrenching surfaces to which the interior polygonal surfaces 210 in the indicator conform and are complementary. In one configuration, the inside dimensions of the polygonal surfaces 210 are selected so that they are slightly smaller than the outside dimensions of the wrenching surfaces 616 of the pin head, so that the indicator fits snugly or tightly over the wrenching surfaces. Other configurations can also be used.

The wrenching surfaces 616 transition to a circumferential or annular groove 618 (FIG. 12) in the outside surface of the head of the pin. In the present example, the annular groove 618 has a substantially cylindrical external surface, extending continuously about the circumference of the head 602. The annular groove 618 receives and positions the upper portion 228 of the indicator so that an inner-most surface geometry on the indicator in the present example is positioned in the annular groove. The annular groove 618 terminates at a lip or shoulder 622 extending radially outward of the head of the pin from the annular groove 618. A perimeter surface of the shoulder 622 converges upward to a top surface 623 of the pin head. The converging perimeter surface forms a frustoconical surface between the bottom of the shoulder 622 and the top surface 623 of the pin head. The frustoconical surface makes easier the installation of the indicator over the head of the pin. Other surface configurations are also possible. Assembly of an indicator 200 on a head of a pin is substantially the same as that described with respect to assembly of the indicator on a nut 300.

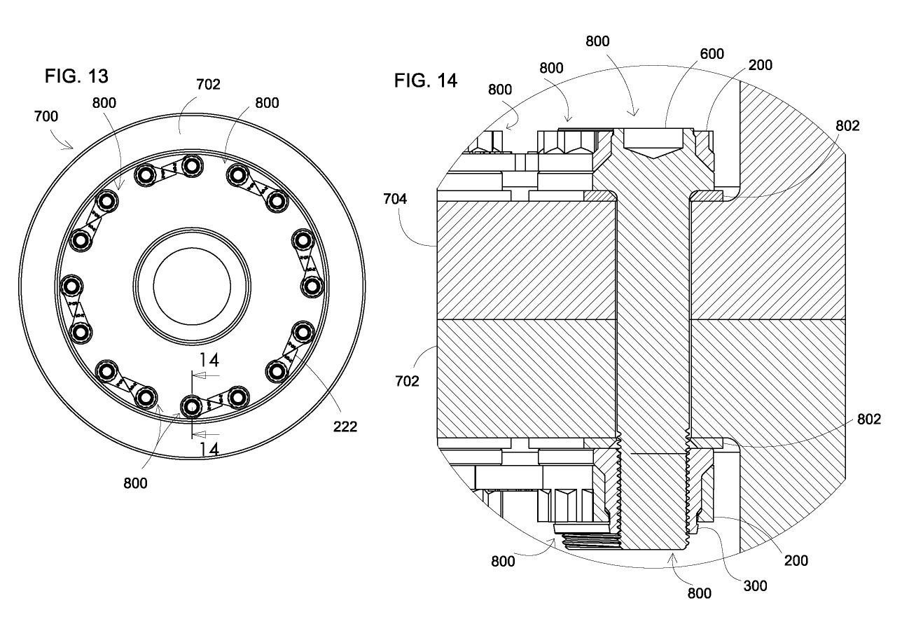

The fastener assemblies such as those described herein have a number of applications, and in one example can be used on wheel assemblies. In one example, a wheel hub assembly 700 (FIGS. 13-14) includes first and second hubs 702 and 704 secured together with a plurality of fastener assemblies 800. The first and second hubs are conventional wheel hubs, which may be configured in a number of ways corresponding to the desired application. In the present example, each fastener assembly includes a pin 600 receiving a nut 300, each of which bear against respective washers 802. Each pin and each nut have respective indicators secured to them, an indicator extending over and retained by a nut through engagement with an annular groove in the nut, and an indicator extending over and retained by the head of the pin through engagement with an annular groove in the head. The indicator on the head of the pin can be used to indicate possible pivoting or movement of the pin relative to the hub 704. In the present example, each fastener assembly includes male and female fastener elements and at least one and as illustrated two indicators on respective ones of the male and female fastener elements. In the case of two indicators, each indicator can be used to identify possible pivoting of its respective fastener element. Any or both of the indicators can also be used to limit movement of the associated fastener element, by positioning the indicator portion 222 adjacent to and/or contacting an external surface, for example a surface on the hub such as a boss, sidewall or other structure fixed relative to the hub, or for example adjacent to and/or contacting a corresponding indicator on an adjacent fastener assembly. For example, an indicator on a head of a fastener can be positioned adjacent to and/or contacting an external surface on the hub, or adjacent to and/or contacting a corresponding indicator on the head of an adjacent fastener assembly. In the example illustrated in FIGS. 13-14, adjacent pairs of fastener assemblies have respective indicators on respective nuts contacting each other, and also respective indicators on respective heads in the same pair of fastener assemblies contacting each other. Alternatively, adjacent pairs of fastener assemblies can have respective indicators on respective nuts contacting each other, while a respective indicator on one head of a fastener assembly in the pair contacts an indicator on a head of a fastener assembly in an adjacent but different pair of fastener assemblies.

Hubs may be assembled by placing them adjacent each other and securing them together with one or more fastener assemblies of the type described herein. A first fastener assembly 800 is secured in an opening aligned in the first and second hubs, and an indicator placed on the head of the pin, and if desired and indicator placed on the nut of the fastener assembly. Indicator portions on each indicator may be placed against surfaces on the corresponding hub, or against indicator portions on and indicator of an adjacent fastener assembly. Adjacent pairs of fastener assemblies can be assembled so that respective indicators on the nuts in the fastener assemblies can contact each other, and respective indicators on the pin heads can contact each other. Other configurations are also possible.

Having thus described several exemplary implementations, it will be apparent that various alterations and modifications can be made without departing from the concepts discussed herein. Such alterations and modifications, though not expressly described above, are nonetheless intended and implied to be within the spirit and scope of the inventions. Accordingly, the foregoing description is intended to be illustrative only.

1. An indicator comprising:
a body extending along an axis, and including an intermediate portion defining a bore having a bore surface, wherein the bore surface includes a plurality of surface portions configured to substantially conform to a complementary surface on an external portion of a fastener;
a base portion at a first end of the body and extending partially around a perimeter of the first end of the body and including an indicator portion; and
characterized in that it comprises a resiliently flexible engagement portion at a second end of the body opposite the first end and having a portion extending inward relative to an outer surface of the body.

2. The indicator of claim 1 wherein the plurality of surface portions extend axially and conform to a plurality of wrenching surfaces on a fastener.

3. The indicator of claim 1 wherein the indicator is formed from a single material.

4. The indicator of claim 1 wherein the outer surface of the body includes axially extending outer surfaces configured for manual gripping or wrenching.

5. The indicator of claim 1 wherein a portion of the bore at the first end of the body includes a frustoconical surface.

6. The indicator of claim 1 wherein the resiliently flexible engagement portion includes an arcuately-extending rim extending inwardly relative to an outer surface of the body.

7. The indicator of claim 6 wherein the rim extends in a circle around the second end of the body.

8. The indicator of claim 1 wherein the resiliently flexible engagement portion includes a frustoconical surface on an interior portion extending at an angle inward from the bore surface.

9. The indicator of claim 1 wherein the resiliently flexible engagement portion forms an end surface of the indicator.

10. An assembly of the indicator of claim 1 and a fastener wherein the fastener includes a body with an external surface having wrenching surfaces substantially conforming to the plurality of surface portions in the bore of the indicator, and a surface with helical engagement surfaces for engaging a complementary fastener, and wherein the fastener body includes an engagement surface for receiving at least a portion of the inwardly extending portion of the indicator.

11. The assembly of claim 10 wherein the fastener engagement surface includes a circumferentially extending groove between a lip on the body of the fastener and the wrenching surfaces.

12. The assembly of claim 10 further including a frustoconical surface extending between the groove and the wrenching surfaces.

13. The assembly of claim 11 wherein the lip includes a frustoconical surface.

14. The assembly of claim 10 wherein the indicator has a relaxed state when the indicator is removed from the fastener, and wherein the resiliently flexible engagement portion is flexed when the indicator is positioned on the fastener.

15. The assembly of claim 10 wherein the plurality of surface portions in the bore of the body of the indicator define a minimum inside diameter of the indicator when the indicator is in a relaxed state, and wherein the wrenching surfaces on the body of the fastener define an outside diameter and a minimum diameter between opposite wrenching surfaces and wherein the minimum diameter between opposite wrenching surfaces is greater than the minimum inside diameter of the indicator.

16. The assembly of claim 1 wherein the fastener is either a nut or a male fastener such as a pin, or a bolt or a screw.

17. A hub assembly having at least one assembly of claim 10.

18. The hub assembly of claim 17 further including at least two adjacent assemblies, wherein at least one pair of adjacent assemblies includes respective indicators on heads of male fasteners in the fastener assemblies.

19. The hub assembly of claim 18 wherein the respective indicators on the heads of the male fasteners of the pair of adjacent fastener assemblies contact each other.

20. A kit for containing a plurality of indicators, the kit comprising:
a container; and
a plurality of indicators wherein at least one indicator is configured to be usable on a particular fastener configuration, the at least one indicator having a body extending along an axis, and including an intermediate portion defining a bore having a bore surface, wherein the bore surface includes a plurality of surface portions configured to substantially conform to a complementary surface on an external portion of a fastener;
a base portion at a first end of the body and extending partially around a perimeter of the first end of the body and including an indicator portion; and characterized in that it comprises
a resiliently flexible engagement portion at a second end of the body opposite the first end and having a portion extending inward relative to an outer surface of the body.
